(19) United States
(12) Patent Application Publication
(10) Pub. No.: US 2014/0046976 A1
(43) Pub. Date: Feb. 13, 2014

(54) SYSTEMS, METHODS, AND USER INTERFACE FOR EFFECTIVELY PRESENTING INFORMATION

(71) Applicants: Guangsheng Zhang, Palo Alto, CA (US); Chizhong Zhang, Palo Alto, CA (US)

(72) Inventors: Guangsheng Zhang, Palo Alto, CA (US); Chizhong Zhang, Palo Alto, CA (US)

(21) Appl. No.: 13/844,143

(22) Filed: Mar. 15, 2013

Related U.S. Application Data
(60) Provisional application No. 61/754,652, filed on Jan. 21, 2013.
(60) Provisional application No. 61/682,205, filed on Aug. 11, 2012.
(60) Provisional application No. 61/749,302, filed on Jan. 5, 2013.

(51) Int. Cl. G06F 17/30

(52) U.S. Cl. CPC G06F 17/30483
USPC 707/772

(57) ABSTRACT

Systems and methods are disclosed for presenting information related to an object including a word or phrase in a text content that is considered as unstructured data. Methods include identifying a term in the text content as a candidate for presenting such information. Once the term is identified, various data sources including document or email search indexes and relational or non-relational databases are searched, and data units related to the selected terms are retrieved and displayed in a user interface with a concurrent view of both the text content containing the term and the related information. Other methods for utilizing various visual effects to concurrently display relevant information associated with various user interface objects are also disclosed. Further methods disclosed include effective ways for handling emails, enhancing social network information presentation and user experiences, as well as enterprise internal message delivery for enterprise healthcare cost-reduction and employee well-being.

### CROSS REFERENCES TO RELATED APPLICATIONS

The present application claims priority to U.S. Provisional Patent Application 61/754,652 entitled “System, Methods, and User Interface for Presenting Information Associated with an Object” filed on Jan. 21, 2013, and U.S. Provisional Patent Application 61/749,302 entitled “System, Methods, and Data Structure for Quantitative Assessment of Contextualized Symbolic Associations” filed by the present inventor on Jan. 5, 2013, and U.S. Provisional Patent Application 61/682,205 entitled “System and Methods for Determining Term Importance and Relevance between Text Contents Using Conceptual Association Datasets” filed on Aug. 11, 2012, the disclosures of which are incorporated herein by reference.

### BACKGROUND OF THE INVENTION

Conventional methods of finding needed information have been mainly through search engines for unstructured data, and database queries for structured data. With properly structured query language and tools, data from structured database can also be presented in various ways such as charts or reports to facilitate information consumption or utilization. A problem with the conventional methods is that the user needs to know how to formulate a good query. On one hand, common search engines require the user to come up with pertinent keywords, which is not always easy for many users, and the engine can often return a long list of results that the user needs to sift through. On the other hand, structured database query language requires special training before the user can use the query language, and requires the user to know what types of data are stored in the database and how they are stored. Both can require a considerable amount of effort on the user's side.

Furthermore, the process of human processing information, including attention, focus, thinking, etc., often requires a continuous information flow or information thread. Having to perform separate queries to access related information while the user's focus is on certain topics can also interrupt the thought process, and all this problems can hinder the productivity and information utilization in an era when fast information processing is a big challenge to many users.

However, problems like the above can be mitigated with a deeper understanding of the issues related to information processing capabilities and characteristics, and with new methods to enable new features of more intelligent products.

### SUMMARY OF THE INVENTION

An objective of the present invention is to provide a system and methods for automatically presenting relevant information to the user without requiring the user to make a specific effort to write a query or performing a search. Furthermore, the relevant information that can be presented to the user can be from various sources of data, including both the structured and unstructured data sources, such as relational or non-relational databases, document search indexes, email search indexes, etc.

The present invention provides systems and methods for automatically presenting relevant information to the user when the user is viewing an object such as a document, an email, an image, or a video, or creating a content containing such objects. For example, when the user is reading or writing a company email regarding the product sales, the present system and methods identifies the topics of the email, and automatically conducts background search to retrieve relevant information about the product sales, from both a search index for unstructured data, or from a database for structured data.

The present invention further provides systems and methods for effectively presenting information for various other purposes including managing emails, and enhancing social network user experiences by organizing and presenting relevant information in a more effective and digestible way.

The present invention further provides systems and methods for reducing the possibility of missing important information when a legitimate email is misclassified as a spam email,

The present invention further provides systems and methods for enterprise or other types of organization's healthcare-related cost reduction and for enhancing employee well-being.

The examples are mainly based on text objects such as documents or emails, and the data sources can include various search indexes and various types of databases, however, it should be understand that the principles and methods applies to other types of data and data sources.

### BRIEF DESCRIPTION OF FIGURES

The following drawings, which are incorporated in and form a part of the specification, illustrate embodiments of the present invention and, together with the description, serve to explain the principles of the invention.

FIG. 1 is a system diagram illustrating an exemplar system for automatically identifying objects and displaying information related to an object.

FIG. 2 illustrates an example of the content and format of information that is retrieved from a database and is displayed in a user interface related to an object in a hierarchical display format.

FIG. 3 illustrates an example of the content and format of information that is retrieved from a document search index and is displayed in a user interface related to an object.

FIG. 4 illustrates an example of a topic tree based on a company topic index.

FIG. 5 illustrates a general overview of a process of determining the display format based on user action history and the estimated current information state.

FIG. 6 illustrates an exemplar embodiment of the present invention where an email and the content of an attached document are concurrently displayed for easy reference.

FIG. 7 illustrates an exemplar embodiment of the present invention where user names or icons are highlighted based on the user's status for more efficient information presentation.

FIG. 8 illustrates an exemplar embodiment of the present invention where emails in a spam folder are highlighted in different ways for identifying possible legitimate emails misclassified as spam emails.

FIG. 9 illustrates an exemplar embodiment with emails by organizing and displaying emails for more efficiently finding a particular email among many.

FIG. 10 illustrates an exemplar embodiment in using a company's email interface to deliver healthcare or company-related message objects to employees.

FIG. 11 illustrates an exemplar embodiment in using a user's home page in an enterprise network to deliver healthcare or company-related message objects to employees.

### DETAILED DESCRIPTION OF THE INVENTION

In U.S. patent application Ser. No. 12/782,545 entitled “System and Methods for Automated Document Topic Discovery, Browsable Search and Document Categorization” filed on May 18, 2010, U.S. patent application Ser. No. 12/972,462 entitled “Automated Topic Discovery in Documents”, filed on Dec. 18, 2010, and U.S. patent application Ser. No. 13/707,940 entitled “Automated Topic Discovery in Documents and Content Categorization”, filed on Dec. 7, 2012, by the present inventor, methods for identifying the prominent or important term as topic terms in a text content are disclosed.

In U.S. patent application Ser. No. 13/241,534 entitled “Assisting Search with Semantic Context and Automated Search Options”, filed by the present inventor on Sep. 23, 2011, search methods for presenting contextual information about the topics being searched for are disclosed. The present invention further extends the methods disclosed in the above referenced disclosures to provide more effective and efficient methods for accessing and utilizing information, especially with what is known as the unstructured data.

As it is known, the information stored in a database, such as a relational database based on tables that store data in rows and columns, or a non-relational database, are usually called the structured data, while information carried in free text format, such as regular documents or emails or web pages, or blogs or instant text messages or comments on a social network, or a transcript or a description of an audio or visual object, a query string entered in a search box, etc., are usually called the unstructured data. In addition to the free text format, other objects that carry information such as a picture or image, a stretch of speech sound or video stream, are also considered as unstructured.

Structured data are usually easier to access and manage and utilize with the aid of software applications such as databases and query languages, while unstructured data require more human efforts to access, digest, and organize. While search engines of various types provide a way of accessing such unstructured data by indexing the terms in various documents for a quick retrieval to serve a keyword-based query, the search results are most of the time links to the original documents that contain the queried keywords, and users still need to read the documents to find the information being looked for. More of a problem is that search engines all require the user to come up with the right keywords and write a query, which requires more efforts on the users' side, especially when the user does not know what exact keyword to use for the query, and what types of contents are available for search. Furthermore, there can be much more useful contents buried in a large amount of data, whether structured or unstructured, but the user may not always know what useful data exist there. More efficient solutions are needed for handling the increasing amount of data in the current information age.

As mentioned above, an objective of the present invention is to provide a system and methods for automatically presenting relevant information to the user without requiring the user to make a specific effort to write a query or performing a search. Furthermore, the relevant information that can be presented to the user can be from various sources of data, including both the structured and unstructured data sources, such as relational or non-relational databases, document search indexes, email search indexes, etc.

The present invention provides a system and methods for automatically presenting relevant information to the user when the user is viewing an object such as a document, an email, an image, or a video, or creating a content containing such objects. For example, when the user is reading or writing a company email regarding the product sales, the present system and methods identifies the topics of the email, and automatically conducts background search to retrieve relevant information about the product sales, from both a search index for unstructured data, or from a database for structured data. In the following illustration, the examples are mainly based on text objects such as documents or emails, and the data sources can include various search indexes and various types of databases.

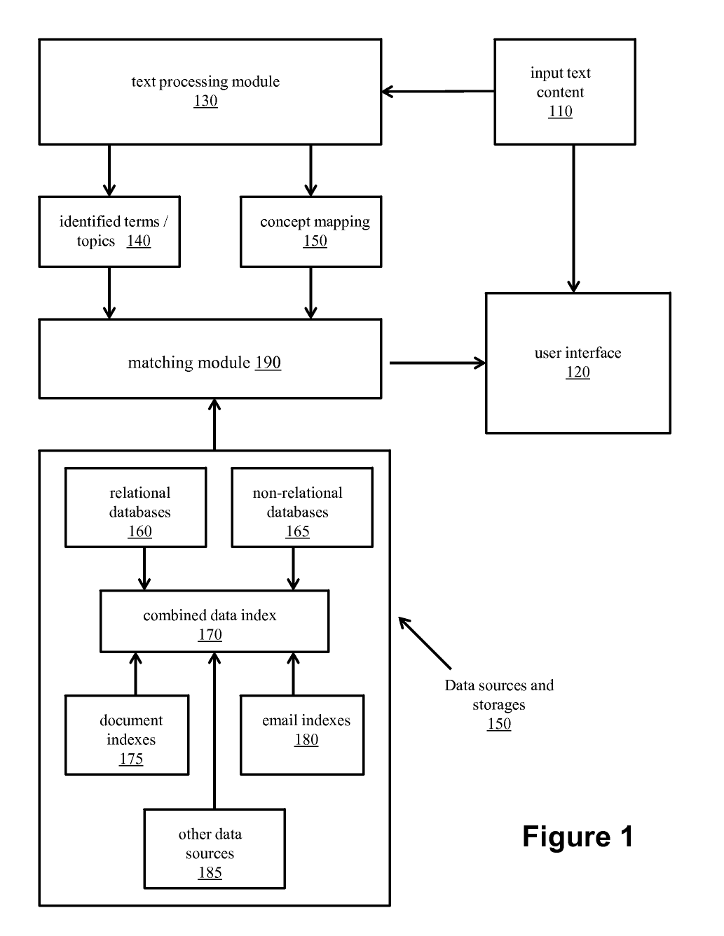

FIG. 1 is an illustration of the main components of a system of the present invention with text contents as exemplar unstructured input data.

In FIG. 1, a text content 110 that is displayed in a user interface 120 for viewing is input to the system. The text content can be a document or an email or other types of contents including web pages or blogs or instant text messages or comments on a social network, or audio video transcripts, etc. The text content is analyzed by the linguistic analysis or text processing module 130, each word or phrases are identified as token instances of terms 140. In some embodiments, the importance of each term can be then determined based on the attributes associated with the term, such as the grammatical or semantic attributes of the term or its instances, as well as the position or frequency of the term. The most important terms are selected as the terms that represent the main topics of the content. In some other embodiments, the text content is mapped to a concept definition 150, and one or more concepts can be identified as being associated with the text content; the names or descriptions and the definitions of the concepts can be obtained from computer storage or user interface. In some still other embodiments, the syntactic or semantic or informational relationships between two or more terms in the text content can be identified, and terms in relationships such as subject-predicate, or a concept name with properties of the concept, etc., can be identified as a term pair or a term group.

In some embodiments, the text content 110 can be in a reading mode, meaning the content is a prewritten content and is being displayed to the user. In some other embodiments, the text content 110 can be in a writing mode, meaning that the words or phrases in the content are being written by the user at the time the content is being analyzed by the system and methods in the present invention.

Then, the data sources 150 available to the system are identified. The data sources can include a relational or non-relational database (160, 165), a document index (175), or an email index (180), or other indexes (185).

The terms or concepts identified in the text content are then matched with one or more data units in the data sources 150 by a matching module 190. A data unit can be a data record or part of a data record such as data in a row or a column in a relational database, or an object in a non-relational database, or an entry in an index, etc. Then, the matched data units are retrieved from the data sources, and displayed in an area or in an object in the user interface 120, in connection with the text content.

The data units displayed are the information related to the text content. With such data automatically searched and retrieved and displayed for the user, the user of the text content may not need to perform an additional query to search for such information. Even though in certain cases the user may not have the intention to search and display such related information, there are cases when users never think such information existed, or never thought about searching for such information due to the inconvenience of performing separate searches, or due to the existence of such information and the method of finding such information being unknown to the users. In some embodiments, when the amount of data units are more than one, the data units can be ranked based on their degree of relevance to the topics of the content, or to a specific term in the content.

When the relevant information is unknown to the user, such information is non-utilizable by the user. One of the advantages of the present system and methods is that such information is automatically presented to the user as readily usable information. It not only saves the user time and efforts in finding relevant information, but also makes certain otherwise hidden information utilizable.

In some embodiments, the present invention is implemented with what is known as the “in-memory databases”, or “real-time databases” for either relational or non-relational databases, or indexes for unstructured data, or unstructured data that are not indexed. In such embodiments, the faster-than-normal speed of data access with such types of databases can enable or enhance the actual effects. In certain cases, especially with the speed issue associated with querying or retrieving from a large amount of data, the implementation of real-time or automatic display of related data as illustrated in the present invention was not practically enabled for the conventional approaches that are based on traditional hardware and software infrastructure. However, one way the present invention distinguishes from the conventional approaches is by taking advantage of the latest development in both hardware and software infrastructure, enabling such automatic or instance display of related data to terms or symbols in unstructured text contents, or objects of other types, such as images or sounds, etc.

The following is a more detailed description of the modules and steps illustrated in FIG. 1. For ease of illustration, the first examples used in the following descriptions are mainly based on use cases in a company or enterprise environment, or other organization environments, with regard to information access and information management processes in such environments.

When the input text is analyzed and terms and their token instances are identified, in some embodiments, one or more terms are selected to match the entries in the data sources that can include relational or non-relational databases and in-memory or real-time databases, sometimes also disk-based databases, and various indexes for unstructured data such as documents and emails, etc.

In some embodiments, each term or object in the content can be a candidate for such automatic matching, and information retrieving and displaying. In other embodiments, important or relevant terms are selected for such information retrieving and displaying. The criteria for selecting which terms in the text content for presenting related information, or for automatically searching, retrieving, and displaying related information, without the user indicating such a search or retrieval or display, can be based on a number of factors.

### Selecting Terms for Automatically Presenting Related Information

As is described with FIG. 1, in some embodiments, a term in the text content is automatically searched against various indexes or databases, and if a match is found, related information from the index or from the database can be displayed to the user, either with or without the user indicating to perform such a search and display.

In some other embodiments, the terms in the input text content can be first analyzed for their importance in representing the main topics of the content, based on the grammatical or semantic or positional attributes of the term.

In U.S. patent application Ser. No. 12/972,462 entitled “Automated Topic Discovery in Documents”, filed on Dec. 18, 2010, and U.S. patent application Ser. No. 13/707,940 entitled “Automated Topic Discovery in Documents and Content Categorization”, filed on Dec. 7, 2012, by the present inventor, system and methods are disclosed for accurately identifying the topics of a text content based on the degree of importance of the terms, and based on the grammatical and semantic attributes of the terms, as well as other attributes such as their internal and external frequencies, and their relationships. In the present invention, the same methods in the referenced disclosure can be used to first determine the importance of each term in the input text content, and then, to select the most important terms in the text content as candidates for presenting related information, or automatically searching, retrieving and displaying the relevant information. The disclosures of the methods for determining the term importance and selecting terms as topic terms are hereby incorporated by reference.

In some other embodiments, contextual information and relationships between the terms in the text content, such as the syntactic or semantic or informational relationships between multiple terms in the text content can be identified. Such relationships include the subject and the predicate of a sentence, a modifier or a head of a multi-word phrase, etc. In U.S. patent application Ser. No. 12/573,134, entitled “System and Methods for Quantitative Assessment of Information in Natural Language Contents” filed on Oct. 4, 2009, and U.S. patent application Ser. No. 12/972,462 entitled “Automated Topic Discovery in Documents”, filed on Dec. 18, 2010, a theoretical framework is disclosed with implementation methods that treat terms in such relationships as representing the informational relationships between an object or concept and its properties. In the present invention, the terms in the input text content that have such a relationship as indicating a concept or topic or attribute and its associated properties can be identified using the methods in the referenced disclosure, and can be selected in the form of a term pair or term group as candidates for automatically displaying related information from data sources. The disclosures of the methods for identifying such relationships are hereby incorporated by reference. And terms meeting the criterion can be selected as candidates for automatically displaying the relevant information.

In U.S. Provisional Patent Application 61/749,302 entitled “System, Methods, and Data Structure for Quantitative Assessment of Contextualized Symbolic Associations” filed by the present inventor on Jan. 5, 2013, methods for using more contextual attributes are disclosed. The methods further include assigning a weighting co-efficient to a term based on its position in the text content, or its position relative to a specific term, or the distance of the term from a specific term, in addition to using the grammatical or semantic contextual information. These methods can also be used for determining the term importance score of the terms in the text content, and the selection of terms for displaying the related information can also be based on the importance scores calculated using these methods.

In some still other embodiments, the text content is mapped to one or more concept definitions. For example, when the content of the text contains certain terms that are related to the concept of “travel” in a certain way, the text content can be mapped to a concept definition in the form of a dataset that comprises at least a plurality of terms related to the activity of “travel”, such as flight, driving, sightseeing, names of places, hotels, etc. The mapping method can match the terms in the input text content with the terms in the concept definition, and determine a relevance score based on the number of terms in the text content that match the terms in the concept definition, or based on other calculation methods such as based on the importance scores of the terms in the text content or in the concept definition dataset. The text content can be identified as being about the topic of “travel” if the relevance score is high enough. The concept definition dataset, or the names or descriptions of the concepts can be obtained from computer storage or other sources including a user interface. Terms related to a specific concept can be selected as candidates for automatically searching, retrieving, and displaying information relegated to the concept. For example, if a text content is determined to be related to the concept or topic of “travel”, terms that are conceptually related to the topic of “travel”, such as “flight”, “driving”, “hotel”, etc., can be selected for automatically presenting related information.

In U.S. patent application Ser. No. 12/573,134, entitled “System and Methods for Quantitative Assessment of Information in Natural Language Contents” filed on Oct. 4, 2009, U.S. patent application Ser. No. 13/732,374 entitled “System and Methods for Quantitative Assessment of Information in Natural Language Contents and For Determining Relevance Using Association Data”, filed on Jan. 1, 2013, and U.S. patent application Ser. No. 13/655,415 entitled “System and Methods for Determining Relevance between Text Contents” filed by the present inventor on Oct. 18, 2012, methods for mapping a text content to a concept are disclosed, and the disclosures are hereby incorporated by reference.

It should be noted that conventional methods may display related information to terms extracted from a databases, such as the names of persons in an address book or contact list, and display a limited number of pre-defined data units such as an email address, or a profile picture. In contrast, in the present invention, the terms or symbols to be selected for presenting the related data are in a content that is or at least contains user-generated text or symbols, such as a document or an email or a webpage or blog or comment, or other data that are known to a person with ordinary skills in the art as “unstructured data”, or in free text format, in contrast to what is known as the “structured data”, such as data in a database. An example of the distinction is that in an email user interface, the text contents in the email message are defined as the user-generated data, or the unstructured data; while other information that can be displayed in the email user interface such as the names of persons who are in the contact list or address book, or email folder names, is defined as non-user-generated content if such information is retrieved as data records from cells in a database, thus is defined as the “structured data”. Conventional methods may only display related information for the names of persons that are extracted from the address book as a database or as structured data, while the present invention can cover the terms or symbols that are in user-generated contents, or in free text format, or as unstructured data. Furthermore, as described above, the present invention can utilize the processing speed associated with real-time or in-memory databases, providing a unique advantage over the conventional methods even when displaying data for terms or symbols extracted from the structured databases.

The methods disclosed in the present invention can also be applied to objects extracted from the structured database, such as the names of persons in the address book or contact list described above. One unique feature of the present invention in displaying related information for object both in the unstructured input data or those objects extracted from structured data sources is to display a plurality of related data dynamically gathered from diverse and real-time data sources in addition to what is known as persistent data in a data source.

For example, in the above case of displaying related information about the names of persons in the address book or contact list, in addition to displaying a brief profile information such as a picture of the person with a few words of description, which are stored in association with the person's preset static profile data in a database, in the present invention, the types of data displayed can also include other information related to the person that is not stored in the same database as the person's profile, but dynamically obtained from other data sources, such as information about the person's recent or past activities, or the projects the person has recently participated or accomplished, or important company meetings the person has attended, or the documents the person has written and submitted.

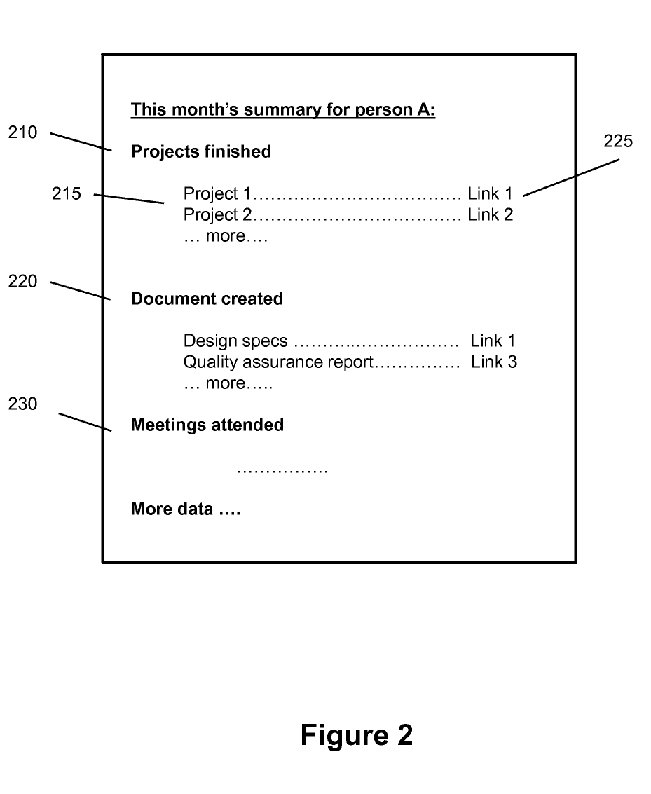

Furthermore, when the available data units for display are multiple, they can not only be ranked by a relevance criterion when displayed in a list format, but also displayed in a hierarchical structure such as a tree format, or a graph or a chart format. FIG. 2 is an example of such a hierarchical display format. In FIG. 2, similar data units are grouped into categories (210, 220, and 230) for easy browsing, and the categories can form a tree structure with lower-level contents (e.g. 215) for organizing and displaying more data. When the number of relevant data units is large, conventional method of displaying the data units in a flat list form will fail to effectively make such data consumable by the user when the list becomes too long. In the present invention, data units can first be organized into a hierarchical structure, and then presented to the user as a convenient categorized summary and a unified access point to the individual data units that would otherwise be difficult to handle when presented in a list format. In U.S. patent application Ser. No. 13/707,940 entitled “Automated Topic Discovery in Documents and Content Categorization”, filed by the present inventor on Dec. 7, 2012, methods are disclosed for building a hierarchical structure for the information units in the unstructured text contents. The same methods can be used for organizing relevant text data units obtained from indexes for documents or emails or other text contents, and can be extended to incorporate data units that are extracted from structured data sources such as relations or non-relational databases. The detailed disclosure of creating such a hierarchical structure is hereby incorporated by reference.

In certain cases, for a given user-generated text content, such as an email message or a webpage, conventional methods may automatically display predetermined advertisements based on certain terms or symbols contained in such unstructured text contents. In contrast, in the present invention, especially when it is in a company or organization environment, instead of or in addition to displaying advertisements, the related data to be presented by the present invention can include business data, such as important data related to the company operations.

### Data Sources and Data Index or Term List

When the input text is analyzed and candidate terms are selected for presenting related information from available data sources, one or more terms can be matched with entries in the data sources; and the types of data sources can include relational or non-relational databases, or in-memory or real-time databases or disk-based databases, and various indexes for unstructured data such as documents and emails.

In some other embodiments, such as in a company or organization environment, entries or objects in such data sources can first be indexed as a company data index, such as illustrated in 170, and the matching can take place between the terms in the text content and the entries in the company data index. In some embodiments, the company data index can contain common topics related to the company's products or services or business operations. In the following description, such a data index can also be named as a company topic index or company topic collection, and can be interchangeably used with the term of “company data index”, or “data index” in short.

In some embodiments, entries in the company topic index can be ranked based on the importance of the entries in the index. For example, words or phrases such as “product quality”, “market segments”, “budgeting”, “cost”, “salary”, “benefit”, etc., may occur more frequently either in company documents or emails, or in table names or record names in various types of databases, and can be ranked higher than other terms. With such a company topic index, the one or more terms in the input text content can be matched with such a company topic index, and data units relevant to the terms in the text content that have a match with an entry in the topic index can be automatically retrieved and displayed to the user. In some embodiments, when there are multiple data units relevant to one or more terms in the text content, or when there are more than one terms in the input text content that match an entry in the topic index, a decision can be made to select the terms in the text that match the most important entries in the topic index, and to display data units that are relevant to the selected terms. In some embodiments, the importance score of the terms in the text content can also be used in selecting the terms to display related data for. For example, a function can be used to select terms in the text content that match an entry in the data index based on the importance score or weight value of the term in the text content, and also the importance score or weight value of a matching term in the entry of a data index.

### Term Importance Score for Both Terms in the Text Content and Terms in the Company Topic Index

In some embodiments, an importance score for an entry in the company topic index can be determined also using the methods in the referenced disclosure as described above, and can further include using the frequency of occurrences of the entry in all the available data sources associated with the company or organization.

In some embodiments, the importance score or weight value of the entries in the topic index can be manually pre-determined and stored. For example, certain terms or symbols can be of particular importance to a specific company or organization, such as “food inspection” for a food company, or “taste” for a restaurant, etc. Such terms or symbols can be assigned higher importance score or weight in the topic index, and play a more important role in determining the dynamic presentation of related data when a text content contains such terms or symbols.

In some embodiments, a list of terms or other symbols can be pre-compiled, either manually or automatically, to serve as a criterion for selecting terms or symbols in the text content for automatic or dynamic or real-time display of related data. For example, a list containing names of specific customers, or specific company activities or events, or specific price range, etc., can be pre-compiled and stored in memory or retrieved from other storage devices. When a reader is reading or writing a text content such as an email or a company document like a word document or a spreadsheet, the terms or symbols in the text content are dynamically matched with the terms or symbols in the pre-compiled list, and when a match is found, the related data can be retrieved from the data sources and be presented to the reader or the writer of the text content.

In some embodiments, one or more semantic attributes or categories can be predefined and a list of terms or symbols or their character string patterns having the predefined semantic attributes can be compiled. For example, US phone numbers, zip code, date and time, address, etc., can have a string character pattern such as a phone number usually having an area code followed by a number of digits. The list of terms or symbols or patterns can be matched with terms or symbols in the text content, and when a match is found, information related to the matched string can be dynamically retrieved and displayed to the user of the text content.

Furthermore, the methods for determining term importance as described can also be applied to the terms or symbols in the string that meet a predefined pattern, in addition to the semantic attributes of the pattern. For example, if the string is a phone number, certain area codes can receive more weight than other area codes depending on the specific needs, and information related to such area codes can be dynamically displayed in connection with the phone number in the text content.

### Data Format

As described above, a data unit can be a data record such as a row or a column in a relational database, or part of a row or a column, or an object in a non-relational database, or a stretch of text associated with an entry in a document or email index, etc. In conventional search indexes for documents or emails, the index is mostly based on the whole documents, and the retrieved search results are mostly links to the documents, and in some cases, with a short summary of the document content related to the search keywords. In the present invention, in some embodiments, the indexes for the unstructured data such as documents or emails can be based on sentences or paragraphs, or in some case, based on phrases, such that the relevant data units displayed in connection with the input text content are not limited to the links to the original documents or emails. They can also be the specific text containing information relevant to the terms in the input text content, such that, specific information relevant to the terms in the text content can be presented to the user, whether the user is reading the text content, or writing a document or email.

For example, if the indexed documents contain sentences such as “The shipping cost increased two times in the last year”, and “Shipping cost was partly compensated by the volume of sales”, etc., and if the term “shipping cost” is identified as a candidate term for automatically displaying information, then, if the user moves a pointing device over the term “shipping” cost” when reading an company email or document, or when the user is writing an email or a report that relates to shipping cost, as soon as the term “shipping cost” is recognized by the system, text string such as “increased two times in the last year”, and “partly compensated by the volume of sales”, etc, can be displayed to the user, either in a pop-up window, or in a designated area in the user interface. This way, the user can immediately know what happened to the shipping cost, etc., without perform separate queries to find such information, which can sometimes be distracting to what the user is doing.

In some embodiments, linguistic analysis can be applied to identify the meaningful units in a sentence or paragraph that contain information related to the selected terms in the input text content, and such meaningful units can be used as the data units to be displayed to the user. For example, when a user is entering a keyword in a query, the search results can contain links to document, or a stretch of text containing the keyword can also be extracted from the documents and displayed to the user as the search results. However, some conventional search engines extract a stretch of the text only based on the number of words surrounding the keyword, without being able to accurately extract the meaningful units that contain the keyword. For example, for an exemplar keyword like “information”, without accurate linguistic analysis, a stretch of text such as “in information” can be extracted and presented to the user as a search result. In the present invention, linguistic analysis can be performed to identify the meaningful units that either contain the keyword or are related to the keyword, such as a phrase like “in information management”, or “increased two times in the last year” and “partly compensated by the volume of sales”, and display such meaningful unit as data related to the search query, instead of displaying a link to a document, as is done in the conventional search results currently in the market.

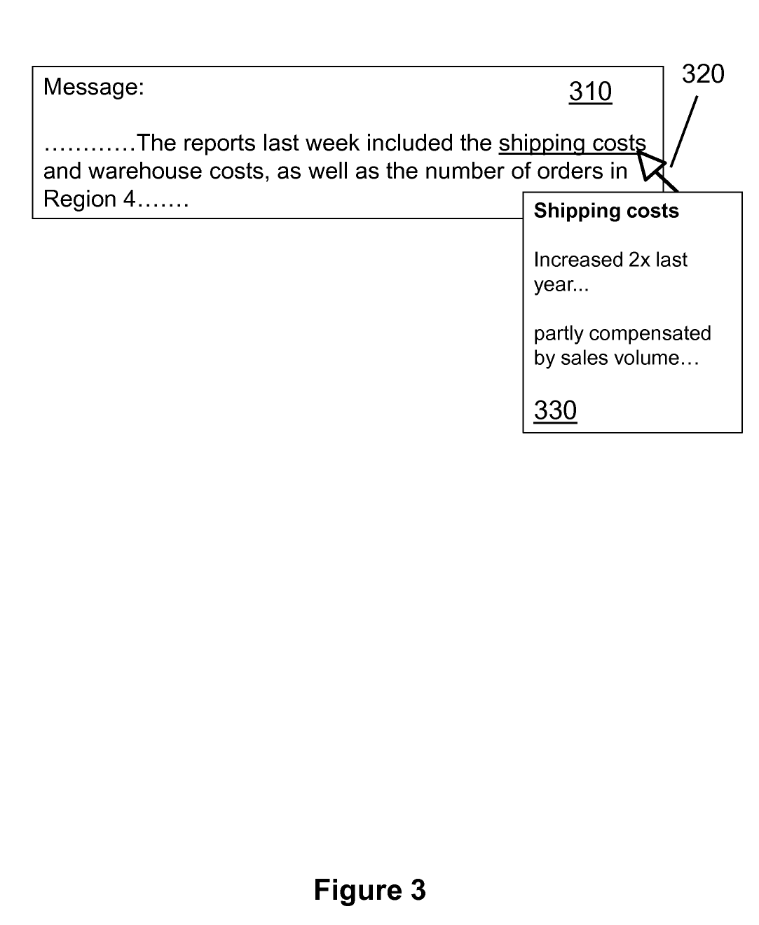

FIG. 3 illustrates an example for such an application. In FIG. 3, a message 310 is being displayed. The message contains a phrase “shipping cost”, which can optionally be highlighted such as with an underline. When a user moves a pointing device 320 over the phrase, a popup window 330 can appear and information related to the phrase “shipping cost” can be displayed to the user. This way, the user can immediately get information related to the topic, without the need to perform a separate search, which can be distracting when reading a message.

In contrast to a search index, when the relevant data reside in a relational or non-relational database, in some embodiments, the data units to be displayed to the user can be a data record or part of a data record in the database, such as a row or a column or part of it, which can also include non-text or character-based symbols, such as images, or audio data. In some other embodiments, the data unit to be displayed to the user can be a report or other visualization formats based on the data in the database. For example, if the terms in the text content is “shipping cost”, and it matches an entry in the company topic index, and the data source is a relational database contain a large number of data related to shipping cost, a report with charts or graphs can be displayed to the user showing shipping cost related to different product names, time periods, and geographical areas, etc. Such a report can be a predefined or pre-stored report, or can also be a report that is generated on the fly, or be modified by the user after displaying an initial version. In another exemplar case, if an email contains a customer name or employee name, related data about the customer or the employee can be automatically made available to the reader or writer that has appropriate access permissions, or can be made readily accessible, using the methods disclosed in the present invention.

An apparent advantage of this is that if a manager of the company is reading a document or email that mentions the shipping cost, the manager can immediately view a report of the shipping cost, without making extra efforts in launching the database interface, writing a query to search the data, and generating a report. With the system and methods of the present invention, everything is done automatically in the background, and making the relevant information at the fingertips of the user.

In some embodiments, the data sources can include pre-stored data sources such as various document or email indexes and relational or non-relational databases, or in-memory or disk-based databases; or real-time data sources such as web feeds or social or mobile data monitoring tools.

### Highlighting and Display

In some embodiments, for one or more terms in the text content that meet the criterion for displaying related information retrieved either from a database or an index for unstructured data, such terms can be highlighted in the text content to indicate that related information is available for such terms, and if the user selects a highlighted term, the related information can be displayed alongside the text content.

In some embodiments, the terms meeting the criterion can also be displayed with other visual effects, such as flashing periodically to indicate that related information is available, or is displayed in a separate display area.

In some embodiments, such terms can be extracted from the text content and displayed in a separate area or a display object in the user interface, such as a separate window, a menu or a dropdown list, and users can select a term to display the related information.

In some other embodiments, the terms that meet the criterion for displaying related information are not highlighted, and the related information is automatically displayed in the displaying area for users to view or select. In such embodiments, when there are multiple data units to be displayed, the order of display can be based on the importance scores of the terms or the entries that math the terms. In some embodiments, the multiple data units being displayed can be in an automatic scrolling format.

In some still other embodiments, the terms that meet the criterion for displaying related information are either highlighted or not highlighted, and the related information can be automatically displayed in the displaying area when the term is either clicked or selected by a pointing device or by a physical touch on a touch screen, or when a pointing device such as a mouse is moved over the term, whether intentionally or unintentionally.

In some embodiments, the criterion for displaying information for the term is defined by user action, such as when the term is either clicked or selected by a pointing device or by physical touch on a touch screen, or when a pointing device such as a mouse is moved over the term. In some embodiments, when the user acts on the term, a dropdown or popup menu can be displayed to either display the retrieved data units, or to let the user initiate a search or display for such data units.

In some embodiments, the term is an individual word of a multi-word phrase, in such cases, an option can be provided in the popup menu for the user to either search or display based on the single word, or based on the multi-word phrase that includes the word.

In some embodiments, the terms that meet the criterion for displaying related information are embedded with links to relevant data units.

In some embodiments, a user interface object such as a button can be provided for the user to indicate or enable or disable the dynamic real-time data presentation.

In some embodiments, the names or descriptions of the data sources where the related information resides can also be displayed in such user interface objects, and the user can select a data source to display the information from the selected data source. For example, the data source names such as the database name or table name, or document index name or email index name can be displayed in the user interface object, and the user can select one or more of the data sources to display the related information.

In some embodiments, the method of highlighting the selected terms can be different for terms associated with different importance score, or also based on the importance score of the entry in the data index that matched the selected term. For example, the color or font type or size can be different for terms of different importance such that the user can decide whether to look at the related information for a particular term or not. In some other embodiments, the data display window can also be different in size, shape or color, or position, etc., to indicate the importance or relevance of the related data being displayed in the window.

Conceptual Matching with Data Units

As described above for selecting terms in the input text content, in some other embodiments, the text content is mapped to one or more concept definitions. For example, when the content of the text contains certain terms that are related to the concept of “travel” in a certain way, the text content can be mapped to a concept definition that comprises at least a plurality of terms related to the activity of “travel”, such as flight, driving, sightseeing, names of places, hotels, etc.; and the mapping method can determine a relevance score based on the number of terms in the text content that match the terms in the concept definition, or based on other calculation methods such as based on the importance scores of the terms in the text content or in the concept definition dataset, the text content can be identified as being about the topic of “travel” if the relevance score is high enough.

On the other hand, the data units in various data sources can also be mapped to a concept using the same methods. If one or more concepts are identified to be close enough to the contents in the text, then the data units that are also close enough to the same concept can be displayed to the user, even though the text content does not contain a specific keyword that matches a data unit. For example, if the text content contains the terms of “airplane ticket”, “hotel reservation”, among others, related data units or reports based on databases containing information about company's travel activities and expenses in terms of time and regions can be retrieved and displayed to the user, even though such data units do not necessarily match a term in the text units. For example, data units described by terms such as “travel expense”, “travel budget”, etc., can be considered as being conceptually relevant to the terms in the input text content.

As is described above, in U.S. patent application Ser. No. 12/573,134, entitled “System and Methods for Quantitative Assessment of Information in Natural Language Contents” filed on Oct. 4, 2009, and U.S. patent application Ser. No. 13/655,415 entitled “System and Methods for Determining Relevance between Text Contents” filed on Oct. 18, 2012, system and methods are disclosed for determining the relevance between a text content and a concept. The disclosures in these patent applications are incorporated herein by reference.

### Hierarchical Structure for Company Topic Data Index

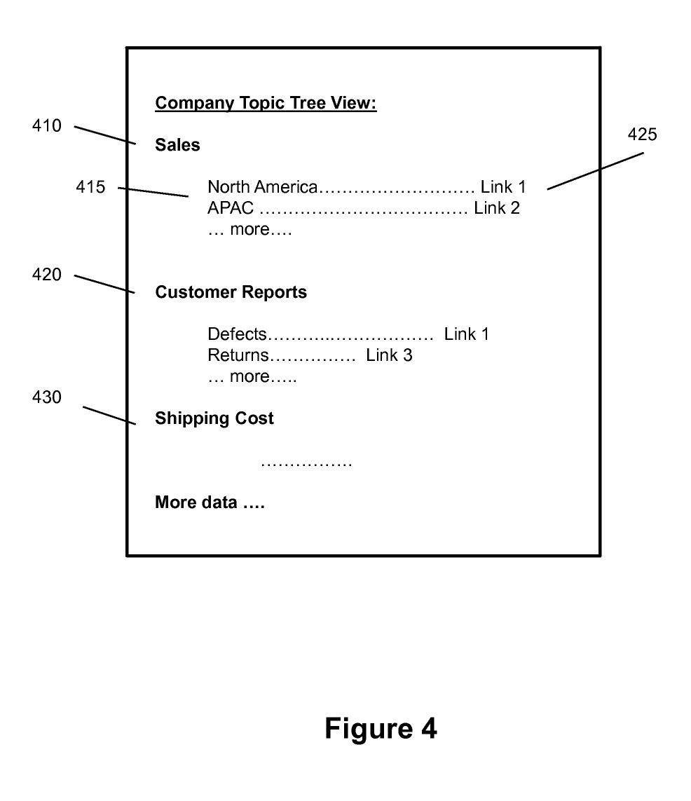

With the importance score determined for entries in the topic index, in the present invention, a hierarchical or tree structure can be created based on the topic index that is created from the available data in the company, including both the structured and unstructured data. In the referenced disclosures of U.S. patent application Ser. No. 12/782,545 entitled “System and Methods for Automated Document Topic Discovery, Browsable Search and Document Categorization” filed on May 18, 2010, and U.S. patent application Ser. No. 13/707,940 entitled “Automated Topic Discovery in Documents and Content Categorization”, filed by the present inventor on Dec. 7, 2012, methods are disclosed for building a tree structure for organizing and representing the informational relationships between the terms or topics based on text documents or segments of text documents, and for browsable search in a company or organization environment. In the present invention, the methods can be extended to building a topic tree from a company topic index that are based on both the unstructured text documents and structured data in databases of various types. With a topic tree structure of this type, all data in the company can be easily accessed by browsing through the topic tree, without requiring the user to design a complex query using a query language, thus greatly improving the productivity and information utilization. FIG. 4 is an example of a topic tree based on a company topic index.

In FIG. 4, topics are represented by the nodes in the different levels of the tree structure, such as the first-level nodes (410, 420, and 430), representing major topics, and the second-level nodes 415, representing minor topics or data values, and their relationships. A link 425 to relevant data can also be added. The topic tree can be built up by a similar method disclosed in the referenced disclosure by using the attributes associated with the data units in the databases and in the unstructured data sources to first determine an importance score for each entry in the topic index, and then ranking the entries by their importance, selecting the most important entries as the first-level nodes of a hierarchical tree structure, and then identifying a second level of nodes under each first level nodes using the importance scores associated with the data units that are linked to each of the first level nodes.

When the entries in the topic index are pointing to text data in documents or emails, the same methods in the referenced disclosure can be used.

When the entries in the topic index point to data in the structured databases, the importance score of a data unit can be determined based on the frequency of occurrences of the data item, or frequency of access to the data units, or the number of data units that contain the entry name and the total number of data units in the databases, or the corresponding frequency data in external databases as comparison dataset. And the entries in the structured database can be merged with entries obtained from unstructured data such as documents or emails.

With such a topic tree for all the structured and unstructured data in a company or organization, users can easily and instantly access a large amount of data by browsing the topic tree, and discover data that are otherwise unnoticed or inaccessible.

The methods disclosed in the referenced disclosures are incorporated herein by reference.

In some other embodiments, the input text content can be a search query, which can be treated as part of a user-generated unstructured data content. In such a case, when a user enters a keyword in a query box, as soon as the keyword is recognized, the keyword can be treated as a term in a textual content, and information related to the topic represented by the term can be dynamically displayed to the user before the search results in the form of links to the documents can be displayed. And as described above, the information can be displayed in a format that shows the specific instances of the text that contain the keyword, or in a format that organizes the context information about the multiple occurrences of the keyword into a tree structure, and instantly display such information, as an alternative to conventional search results. In U.S. patent application Ser. No. 13/241,534 entitled “Assisting Search with Semantic Context and Automated Search Options”, filed by the present inventor on Sep. 23, 2011, system and methods are disclosed for instantly displaying contextual information about the object or topic being searched. In the present invention, the instant display of the context information for the search query can be extended to include the related information about the topic or concept represented by the terms in the query, in a similar format as described above with other examples. The disclosure in this patent application is incorporated hereby by reference.

Furthermore, the objects in the user-generated data can be extended from terms as objects in the textual contents to objects in non-textual contents such as pictures or maps. For example, when an object in a picture, such as the object of a tree, a person, can be identified among other things in the picture, and if information about such a tree or person is available from certain data sources, then, such information can be either automatically displayed to the user, or displayed when the user selects the object or moves a pointing device over the object or touch an icon of the object, or the object can be highlighted for the user to know that related information is available for such object, etc. The objects in a graphic content can be identified either by using an image-recognition tool, or by manually tagging the object such as attaching a person's name to a person's image in a picture.

In some embodiments, the methods of the present invention can also be applied to an audio object such as a sound object. For example, the object can be a word or phrase in a speech recognized by a speech recognition tool, or a voice signature of a person, or the chirping of a bird, or other sound produced by an animal or a machine or by a natural event, or a piece of music or a song, etc. When the object is recognized, related information can be retrieved from various data sources, and can be displayed or signaled to the user either in real-time or in a delayed mode.

In addition to the objects in the unstructured textual contents as described above, certain types of objects in non-textual contents can also be obtained from structured data sources such as databases. For example, icons or names of stores or building or streets in an electronic map are objects in a non-textual content, but such objects can be obtained from structured data sources such as databases. In such a case, related information also from the database can be readily displayed. A number of products currently in the market, such as various online map providers, display some brief profile information about such objects when the user moves a pointing device over an object icon. In the present invention, more data with more formats can be displayed to provide more information about the objects. For example, a large number of relevant information can first be organized into a hierarchical structure, and then displayed in such a format as an access point for users to obtain more information about such objects, without going to a different page to perform a separate query, and the data can also be retrieved from in-memory databases, etc., for real-time-enabled display.

For objects from structured data sources, the present invention provides additional more effective and informative methods than conventional approaches for displaying information related to such objects. The following is a more detailed description of the additional system and methods.

### System and Methods for Determining the Relevance of Information Based on Historic or Usage Data or Based on Estimates of User Knowledge State

In U.S. patent application Ser. No. 12/573,134, entitled “System and Methods for Quantitative Assessment of Information in Natural Language Contents” filed by the present inventor on Oct. 4, 2009, methods are disclosed for quantitatively assessing information contained in natural language contents. The methods are based on a theoretical framework called Object-Properties Association Model of Language and Information, developed by the present inventor. In addition to the methods for measuring the amount of information contained in text contents as disclosed in the above disclosure, one assumption of the model is that measurement of the amount of information that a message carries can also be dependent on the knowledge state of the receiver of the message, in addition to other aspects of the message. For example, for the same sentence “A computer has a CPU”, to a person who does not have good knowledge about computers, this sentence carries a good amount of information about computer as an object in the world. However, to a person who knows very well about what a computer is, the same sentence would not be considered to be very informative, relatively to the receiver of the message, or does not really carry much information about the object of the computer.

In the present invention, additional systems and methods are provided to determine the relevance of information carried by various data units or data types that are to be displayed to the user, and to select the data units that are determined to be more informative to the user based on the estimates of the user's current knowledge state, and use such estimates as a basis to determine the method of displaying available data units related to the objects the user is viewing or dealing with.

In some embodiments, the present system determines the user environment by associating an ID with a specific user who has viewed or produced an object in a user interface, and registers the number of times an object has been viewed or has appeared in the user interface, and the specific data contents displayed with the object. As described above, the object can be a word or a phrase in a text content, or an image object such as an icon or picture in a graphic format, or an audio object.

In some embodiments, the present system makes an estimate of the knowledge state of the user based on the historic or usage data registered above, and makes a decision based on the estimate for displaying alternative data related to the object, to make the data in the displaying area more informative to the user.

For example, in an email user interface, such as the current Web-based Gmail interface, a list of the names of contacts are displayed. When a user moves a mouse over a contact's name in the contact list view area, a profile picture of the contact may be displayed in a popup window or box as additional information about the contact. This feature can be useful to many; however, if the contact never changes his or her profile picture, the same picture can be displayed again and again. Eventually, this type of display can lose its function of providing information about how the picture looks like, as the email user already knows what the picture will be when moving the mouse over the contact's name or icon. In other words, the amount of information such a picture carries to the same email user becomes less and less when the user's knowledge about such information accumulates.

In the present invention, the system checks to see how many times the same picture has been displayed, and whether there are other types of data that can be displayed. In some embodiments, if the systems finds that the same picture has been displayed for many times such that it no longer carries as much information as it first appeared, but the contact has other activities such as having sent certain emails to the user recently or in the past, or the system has information about other activities associated with the contact that can be displayed, then the system can alternatively display one or more pieces of such other information when the user moves a pointing device over the contact name icon, or touches on the icon. Such alternative information can be a brief list or summary of the emails sent from this contact, or other updates associated with the particular contact, etc. This way, the email user can easily obtain more information from the same display area, and the data being displayed can be more informative to the user.

For another example, in a social network or professional network page such as the currently well-known sites like Facebook, or LinkedIn, or Google Plus, or some enterprise social networks or collaboration sites, icons or names of contacts or friends are often displayed on the user's home page. When a user moves a pointing device over an icon of a friend or a contact, usually a popup window will appear showing some profile information about the friend or contact, or also with a picture, or a link to the contact's full profile page. However, similar to the examples with the email contact list described above, such information about the contact or friend can often be unchanged for a long time, but can be repeatedly displayed. When a user is familiar what such icons will show when moving the mouse over, the display of the same data carries no more information, and the function of displaying such information can be reduced or lost, or the space for displaying such known information is wasted.

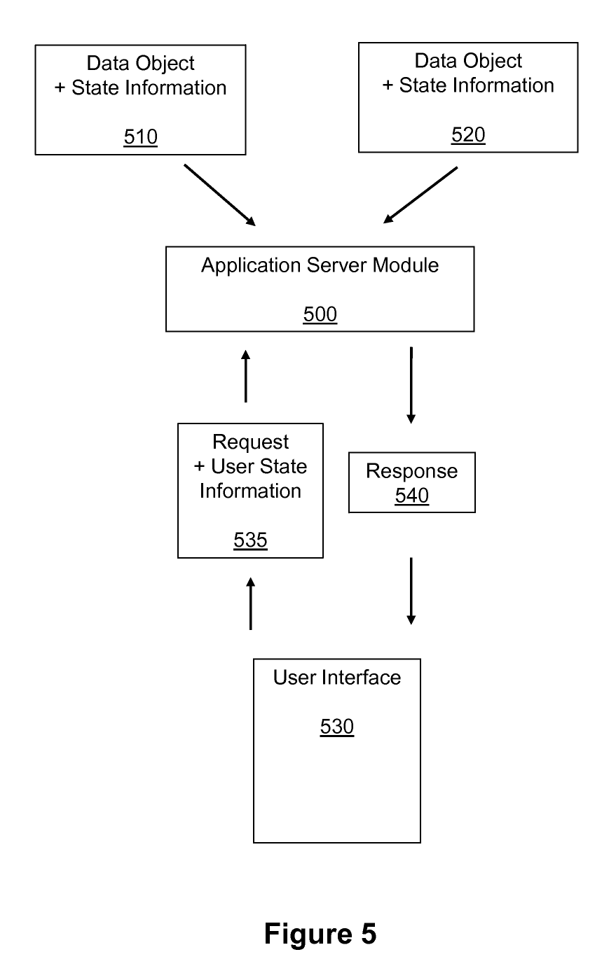

As an alternative to the conventional approach, FIG. 5 illustrates a general overview of one embodiment of the present invention. A user's action, through user interface 530, can be translated to a system request 535 to the application module 500. Request 535 can be any signal given by the user to the application module, such as visiting a webpage, clicking a link or button, entering text, etc., that indicates a retrieval of information from the system database. Request 535 also contains information relevant to the state of the user associated with the current system. For example, suppose a user requests to see information regarding a contact within his social network. The user's state information can be stored in cookies within a web browser, or stored on a web server. Request 535 is analyzed by the application module 500, which can then retrieve an initial data object 510. Data objects can be an image, video, text content, or any type of data that can be stored in the system database and displayed to the user. Before the contents of data object 510 are displayed to the user, the user's state information can be analyzed. Optionally, the state information of the data object can also be analyzed. The system can detect how many times the same data object has been displayed and can make an estimate of the knowledge state of the user based on this number. The system can also detect whether there are other data available for display. The system can then decide whether to display alternative data such as data object 520, which can include a list of recent activities or updates of that contact or friend, or part of such data, as more useful data to the user, and return the data as response 540 to be displayed in the user interface.

In this example, suppose the user has requested information regarding a contact in his social network, and the initial data object is a profile picture of the contact. The system can determine that the user has seen this profile picture many times already, and can decide to display the latest status update by this contact. This method can significantly enhance the user experiences for many users. In some embodiments, a random or pseudo-random number generator can be used to determine which data object to retrieve and display. For example, a profile picture from a user's collection of profile pictures on a social network can randomly be selected to be displayed.

Furthermore, in the user interface, the size or shape or position of the displaying area can also be changed according to whether more informative data is being displayed or not, or based on an estimate of the user's knowledge state as described above. In some embodiments, when the system detects that the user has viewed an object for a certain number of times, or an object has been displayed to the user for certain number of times, or the same data content has been displayed with the object for a certain number of times, the system can change the way of displaying the related information from displaying the same old information in a relatively larger area to a smaller tip window, such that the viewing area is smaller as not to block the view of other objects since the information displayed in the viewing area is no longer as informative as it was before. On the other hand, if the system detects that an object has not been viewed by the user for a certain number of times, based on the principle that the data can still be informative or carrying more information relative to the specific user, a larger display window can be enabled when the object is either intentionally or unintentionally selected by the user.

The same methods of estimating the user knowledge state can also be applied to ranking the results from a search or for displaying online advertisements. In conventional search, documents containing information about a topic represented by a keyword in a query is retrieved and ranked by a relevance criterion based on a number of factors, mostly based on the frequency of the keyword in the documents, based on the assumption that more frequent the keyword occurs in the document, the more information about the topic represented by the keyword is contained in the document. Some conventional methods require the user to give feedback as to whether the initial results are relevant or not, in order to fine tune the relevance ranking.

In contrast to the conventional methods, the present invention can use the historical or usage data that can indicate the knowledge or interest state of the user in terms of how many times the user has accessed the same document, or how similar a document is to the topics that the user has viewed or dealt with in the past; and rank the search results by how informative a document can be relative to the specific user based on what the user may already know.

While this may seem to be a type of personalization, however, the present invention differs from the conventional approach in that in the conventional approach, the more a person searches for a topic, the more likely the information related to the topic will be considered relevant and will be ranked higher in the search results. When this may serve the purpose in certain cases, in many other cases, the situation can be the opposite. For example, if the user is searching with the keyword of “computer” many times, and past data indicate that the documents viewed in the past contain comprehensive information about computers, then, in the present invention, this fact can be interpreted as that the person may have already gained a good amount of knowledge about computers. If the person is searching a document about computers again, candidate documents that contain generic or even comprehensive information about computers can actually be ranked lower than documents containing more specific information about computers. For example, documents about specific aspects, such as specific features and configurations of computers can now be ranked higher than the documents that are more about general aspects of computers, such as an online encyclopedia like Wikipedia article, which is most of the time ranked much higher than any other documents from the results of many dominant online search engines currently in the market.

In U.S. patent application Ser. No. 12/699,193, titled “System and Methods for Ranking Documents Based on Content Characteristics”, filed on Feb. 3, 2010, and U.S. patent application Ser. No. 13/399,050, titled “System and Methods for Ranking Documents Based on Content Characteristics”, filed on Feb. 17, 2012, system and methods are disclosed for determining whether a document contains general or specific contents about an object or a topic, and can thus be utilized by the system and methods of the present invention. The disclosure is hereby incorporated by reference.

In addition to document search, in the case of online advertising, such as automatic display of banner advertisements based on a person's search history, or advertisement clicking history, such as what and how often a user has clicked an advertisement of a certain type, conventional approaches are likely to display more of the same or similar advertisements, as being perceived by many users, probably based on the assumption that the more the person clicks, the more it shows the person's interest in the goods or services or topics related to the advertisements that are clicked or viewed. Again, while this approach may serve its own purpose in certain cases, in many other cases, the same or similar advertisements can become irrelevant if the user has known enough about the goods or service or topic, or has simply purchased something of this type. In such cases, the repeated display of advertisement can be a waste of resources on the merchant's side, and the users can even be annoyed by the repetition. In the present invention, such historic data can be interpreted as that the user has gained enough knowledge about the goods or services or topics, and what can be more informative to the user can be something else, such as alternatives to the type of goods or services or brands. For example, suppose a user has searched with the keyword of “computer”, or clicked on many advertisements related to desktop-computer. In the present invention, advertisements of alternative types of computers or computer brands, or alternative devices to regular desktop computers such as tablet computers or smartphones, etc., can be displayed, instead of repeating what the user has already looked at. And in many cases, this can be a more effective method for advertising and more informative to the user as well.

The system and methods for displaying related information based on the estimate of user's historical or usage data described above can also be applied to the objects in the unstructured data contents, such as the terms in text contents, or images in graphical contents, or sounds in audio contents. This is in addition to determining which data to be displayed or to be made available for display based on the importance of the terms or symbols in the contents, or the importance of the matching entries in the data index.

The above examples are mainly based on company environments. It should be clear that the methods can apply to any environment, including personal computing environment, Internet environments, and other organizational environments such as educational, governmental environments, etc.

Linking and Displaying Email Attachments with Description in Email Contents

A problem faced by many current email users is that when the sender of the email attaches a document, and describes or explains certain points in the attached document for the receiver's specific attention, the description is out of the context since the document is not open or viewable when the receiver is reading the email, and if there are multiple documents attached, after downloading the attachments, the receiver can find it difficult to locate the specific points in the documents matching the description in the email message. For example, the sender may say in the email message something like “A special point is made on page 2 of the attached document regarding . . . ”, at the time of reading the message, the receiver can have no idea what is being referred to by the sender, and after downloading and opening the document in a separate window, it can be difficult for the reader to go back the original email message and match the points in the document, as the reading process is much interrupted, and the related information is not available in time within the same focus span.

In the present invention, a solution is provided by displaying the content of the attached document in a separate but connected viewing area, automatically or in real-time before downloading, such as displaying in a pane on the left or right side or other places of the email viewing page, or in a popup window when the user points to the document icon, or when the reader moves a pointing device to the text in the email describing the content of the attached document. In some embodiments, the system automatically detects the words used in the email such as “in the attachment”, etc., and if an attachment is found being linked to the email, the system automatically, or upon indication by the user, retrieves the content of the attached document, with or without actual downloading the document and save it to local storage, and displays the content in the preview area.

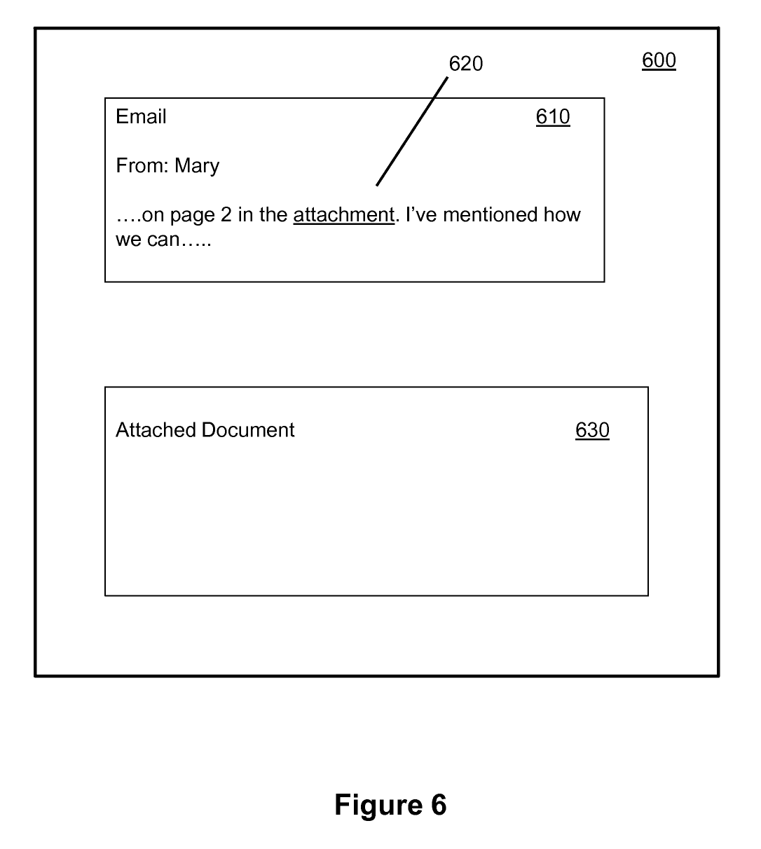

FIG. 6 illustrates one embodiment of the present invention where user interface area 600 consists of an email 610 and a separate display area 630. Email 610 contains text that includes the phrase “in the attachment”, and the system can recognize that this refers to the attached document, and optionally underlines the term “attachment” in the document. The system can make the underlined term 620 of “attachment” clickable by a pointer or a touch on a touchscreen as a link, or allow the user to hover over the term with a pointer/mouse, or use some other method of allowing the user to indicate action on the term. Once the user acts on term 620, a view of the attached document can be displayed in display area 630, allowing the user to reference the specific page or section of the attached document mentioned in the email without having to manually download or open the actual attachment. This way, the reader of the email can have an immediate context to understand what the sender is referring to, without having to go back and forth between the email and the document after download and opening the attached document. In some other embodiments, term 620 can be emphasized in a different way other than being underlined, such as being highlighted, placed in bold font, or any other method of distinguishing it from the rest of the text.

The above embodiment with email and attachments is a special case of presenting related information in real-time or near-real time as described in the major part of the present disclosure above. The principle of all these embodiments are basically the same, that is, the process of human processing information, including attention, focus, thinking, etc., often requires a continuous information flow or information thread. Thus, presenting related information in real-time or near real-time and in a near-uninterrupted way such as making related information viewable or accessible on the same page, or in the same user interface, can be crucial to facilitate the process. This is a major point of the present invention.

The same methods can also be applied to images or audio files as attachments. Some existing email products in the market can actually display a thumbnail of the attached images before the use starts to download the images. However, in the present invention, the image can be displayed in the same manner as a document preview described above, and if the sender of the email says something like “The second image shows . . . ”, then the reader can immediately see what the sender is referring to, without his or her thought or attention being interrupted by having to leave the email text to the attachment area, then download, and then re-open the file, then refer back to the email for the description or explanation.

### A System and Methods for Presenting Information Using Special Visual Effects

Under the same principle of presenting related information in an interrupted manner, the methods of the present invention can be further extended to other areas of applications for more efficient information utilization.

One example of the application is with presenting or processing information in a social network environment. In a social network page such as Facebook or LinkedIn, information about friends or contacts can be presented in a more effective way using the principle and methods of the present invention. In a social page like a Facebook page, currently, at the time of this writing, updates of friends are mainly presented by what is known as NewsFeed, which presents the new updates about the user's friends in a scrolling manner. However, an active user can have hundreds or even thousands of friends, and the feeds can take a long time to scroll for the user to find the updates of all his or her friends, or a particular friend.

An alternative solution to this problem provided by the present invention is to use a highlighting visual effect on a friend's name icon in the user's home or contact page, to indicate if the friend has new update since the user last checked out this friend's page. This way, the user can immediately know who has updates and who has not, and can directly go to those he is most interested to know about their updates, and skip those that have not had new updates since the last time the user has checked them out, or skip those that the user is currently not very interested in knowing about their updates, rather than waiting for the newsfeeds to show what is going on with friends.

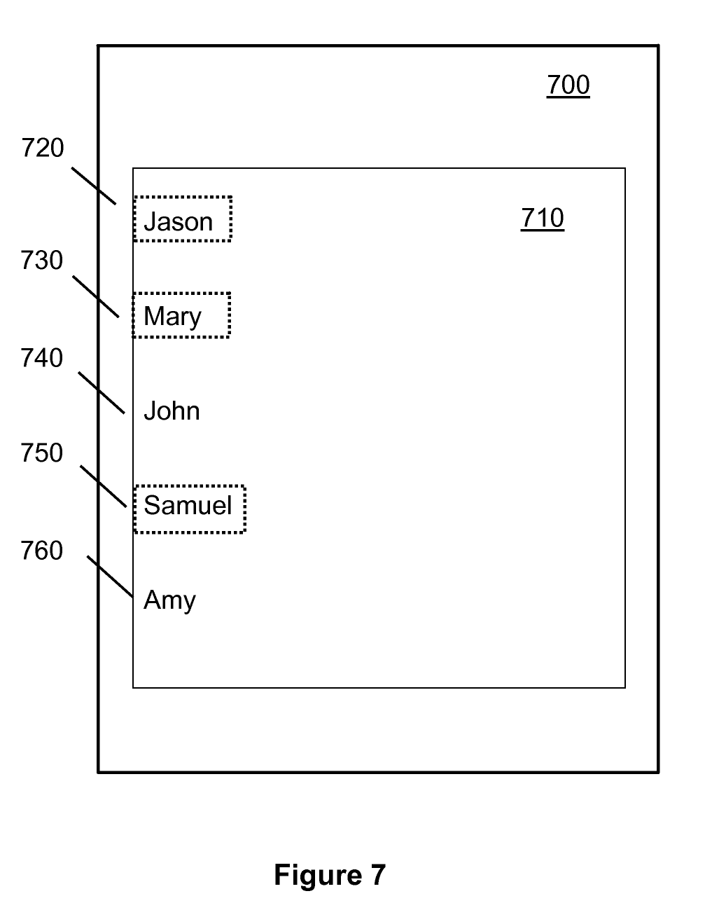

FIG. 7 illustrates one embodiment of the present invention where user names are highlighted in a list of contacts in a user interface. User interface 700 comprises a list of contacts 710, where name icons 720, 730, and 750 are highlighted (represented by dotted lines) to indicate that those friends or contacts have a new update or activity since the last time the user was on the site. In some embodiments, a contact can also be emphasized in other ways instead of highlighting, such as by underlining the name icon, placing an object next to the name, using a different color text, etc., to indicate that the friend or contact has an update or new activity.

Furthermore, instead of listing the contacts or friend in an alphabetic order, or some other static ways, the contact or friend icon list can be sorted by the status change indication to bring the contacts or friends who have status change since last time checked up in the list for faster access.

Furthermore, the highlighting visual format for indicating the status change can be different for changes in different type or degree. For example, the icon can be one color for a change in the profile picture, or another color for a change in an activity, or for multiple changes. In addition to the change in color as a means for indication, the size, shape or position of the icons can also be different in certain ways to convey more specific new information. This way, the icon object can carry and convey much more information while occupying a small space in the viewing area, and the user can receive much more information in an easy way, thus enhancing the user experience as well.

This type of visual emphasis on objects can be extended to other systems including emails. In one embodiment of the present invention, emails are highlighted or distinguished based on properties and content attributes.

In conventional systems, new or unread emails are usually in bold font, while read emails are in plain font, with no highlighting. In the present invention, when email contents can be processed, certain content attributes can be detected, and the email or email preview can be highlighted or distinguished in order to indicate what attribute was detected. For example, in the present invention, if an email does not have a subject line, a few words or a short piece of text related to the contents of the email can be added by the system. The system can mark these preview terms as added by the mail server rather than user-generated. If the email contains no message, then the system can indicate in the subject line or elsewhere that the email is blank or contains no new message. Furthermore, the system can also highlight or present action items, such as terms that indicate some sort of calendar event or urgent task in the email, especially, if a calendar event has a conflicting event in the user's calendar. Many other types of attributes for emails can be detected and used as a basis for visually distinguishing an email and presenting related information, including whether an email contains requests or questions, whether the email is directly addressed to the receiver, or is cc-ed or bcc-ed to the user, etc.

This type of visual emphasis can also be extended to handle a spam mail box in a very useful manner. General spam email filters use certain types of classifiers. In filtering spam emails, from time to time these classifiers can produce false positive errors, which are emails that are not spam but are classified incorrectly as spam. In email communication, false positive misclassification can have serious consequences in certain cases, as critical business or personal information can be missed. An unsophisticated email user may never bother to check the spam email folder, and thus is prone to certain negative consequences.

In the present invention, solutions are provided to minimize such errors by adding new functions to the email system.

Suppose a user wants to check if legitimate emails are misclassified as spam thus mistakenly put in a spam folder. If there are a large number of emails in the spam email folder, this can be a very difficult task. Suppose the user goes through his or her spam mail and notices that a certain email from a sender is not spam. If there are a large number of emails in the spam folder, it could be difficult for the user to find all emails from this sender. One solution provided by the present system is to highlight emails from senders that also have emails residing in the non-spam folders such as the inbox, etc., to indicate a possibility that such emails may be legitimate.

In another embodiment, the email system can generate a notification on a periodic basis that a message from a sender has been classified as a spam email, but at least one previous email from the same sender was accepted before as a non-spam email, or is still residing in a non-spam folder. This is a case when there is a higher probability that the message may not be a spam, such that the user can inspect and make sure no important message is missed by this type of misclassification.

In another embodiment, all emails in the spam folder that are from a particular sender can be highlighted in a color different from emails from other senders. This can be done by the user when a button is provided in the user interface for this function, or automatically by the system. When the user gives an additional indication, such emails can be grouped and displayed on the top of the list, instead of requiring the user to sort all the emails in the folder and then look for emails from this sender. This way, the user can easily check what other emails from that sender are also mistakenly treated as spam by the system, without having to sort the entire folder and then locating a particular group in the list, or to find them one by one.

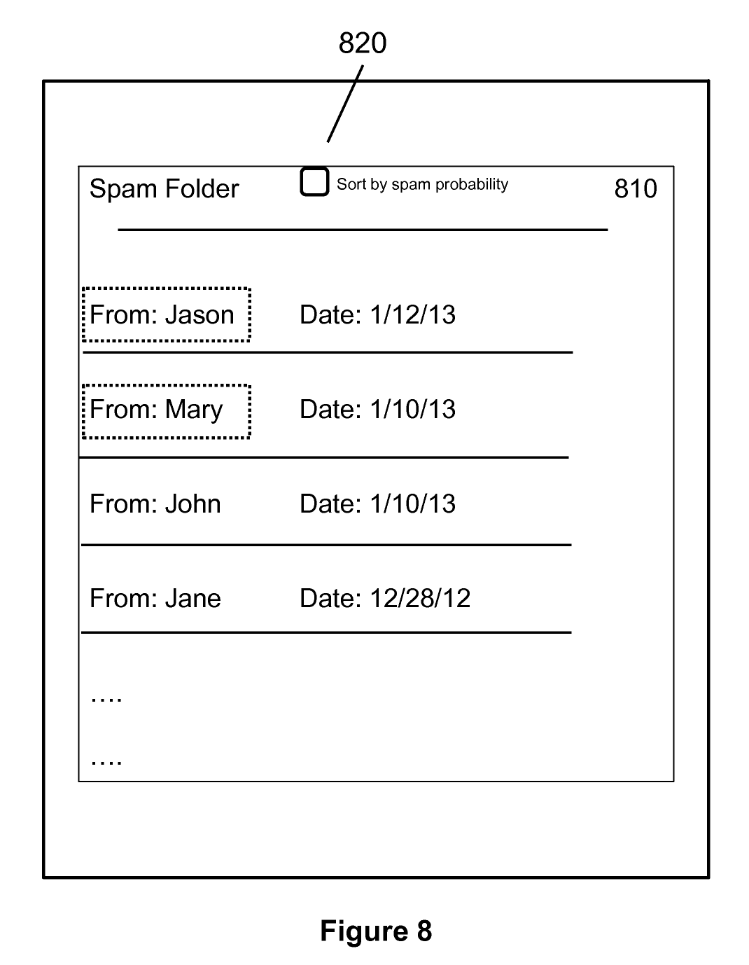

In another embodiment, since a spam mail classifier can usually generate a score based on the probability of the email being spam or not, the spam folder can provide an option to highlight or rank emails by the probability produced by the classifier as spam, such that the user can either easily find possible false positives by the ranking, by the score, or by the visual inspection with highlighting or other visual emphasis effects. FIG. 8 illustrates an example of such an embodiment, where emails in a spam folder 810 are highlighted (represented by the dotted lines) if it is from a sender who has a previous message in a non-spam folder. Optionally, the system can include the option in the form of a button 820 that is selectable by the user to sort the spam emails by a score based on the probability the email is spam. Button 820 can be any form of a user interface object that can allow a user to indicate an action.

### A System and Methods for Organizing and Sorting Data in a User Interface

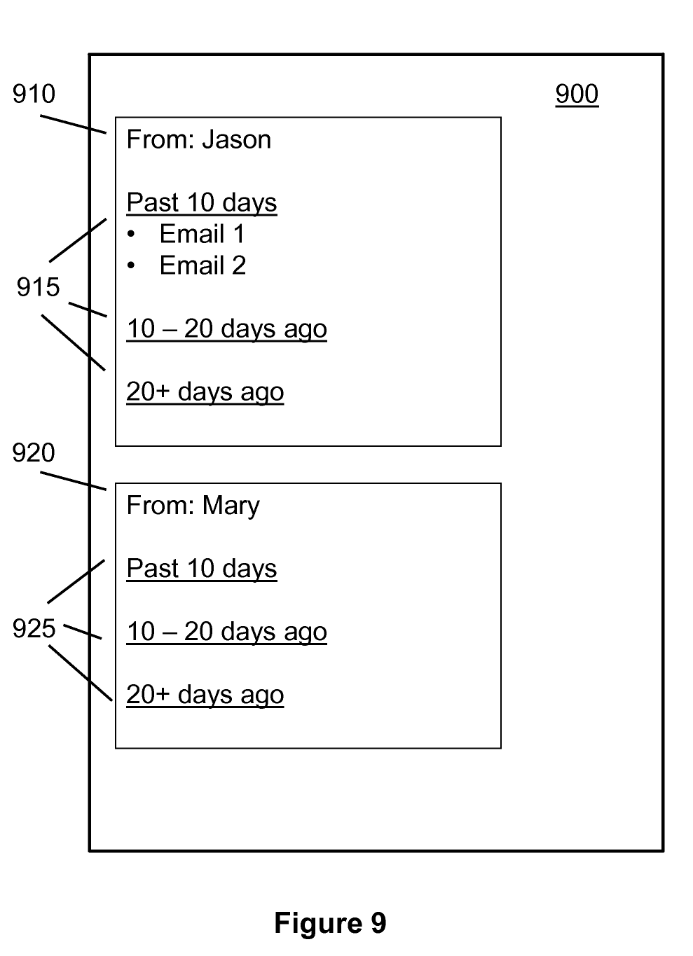

To further facilitate the information organization for easy access and utilization with systems such as email services and social networks, in some embodiments of the present invention, the system can organize data objects into groups or into a hierarchical structure based on data object attributes. FIG. 9 illustrates an example as applied to emails. In email interface 900, the system can group emails by sender as first-level nodes 910 and 920, and then order the first level nodes by when the most recent email was received, or order by the number of emails received from the sender within a certain time range. Second level nodes 915 and 925 can then be time ranges, where each second-level node can display or link to an email received or sent within that time range. In another embodiment, the first level nodes can be time ranges of when an email was received or sent, and the second level nodes can be the senders who have sent message in the corresponding date ranges. In some embodiments, one of the hierarchical structures can be set as the default view, with other types of structures being selectable by the user. An advantage of this is that the user does not need to do search, which can result with a long list of candidates to sift through.

In another embodiment, data object attributes can be used as a basis for sorting or visually emphasizing data icons or objects in a user interface. For example, in an email system, the present invention can color-code an email contact's name or display a value based on the number of times the contact has sent an email to the user in a certain time range. The present invention can also display any updated status messages of the contact in a certain time range.

This example also applies to a social network, where a user can click or hover over a contact's icon or name and information about how many updates, events, or activities the contact has in a certain time range can be displayed, and icons can be sorted by such attributes.

In another embodiment of the present invention, data objects are presented based on a user attribute stored in an enterprise network.

### Displaying Related Information for Non-Commercial Purposes

One format of online advertising in the current market is through free email service systems and web pages. In the free email services, advertisements are displayed in an area alongside the main area of email content display, and likewise with advertisements on many webpages. Some email advertisements are targeted at email users by anonymously analyzing the email content to a certain extent to match the presence of keywords that are associated with entries in an advertisement database, while other methods are based on user browsing history and use such history data to estimate the relevance of advertisements for display. Other systems of online advertising include methods of using a user's social network page for such advertising. These methods can often be effective as many users spend a good amount of time each day looking at their email pages and social network pages.

While irrelevant or inappropriate advertisements can be annoying to many users, relevant advertisements delivered in such formats can serve both the merchant and the consumers well, and achieve tangible economic gains for merchants and various needs of consumers.

However, as a method of communication, the format can be adapted with improved methods for different environments, and can be used to serve non-commercial purpose, or to bring both tangible and intangible gains to many users, organizations, and the society as a whole.

One area of the application is in reducing companies or other organizations' healthcare costs, and promoting employee well-being. With the cost of healthcare skyrocketing in recent years, it has become an issue with many companies or organizations, large or small, to control their benefit cost, while more importantly, to maintain a healthy workforce, for the benefit of both the organization and the employee or members of the various organizations in general, including teachers and students.

In the present invention, one solution to the problem is to adapt the online advertising format to an organization-internal message delivery system, for the purpose of delivering health or medical related messages to the members of the organization, since employees of many companies also spend a good amount of time each day using their email systems or other group collaboration systems. In the present invention, in addition to general purpose company or employee-related message delivery, the content of emails or company webpages can also be detected to a certain extent, and a health-related or company-related message object can be delivered to the targeted users for maximum effect.

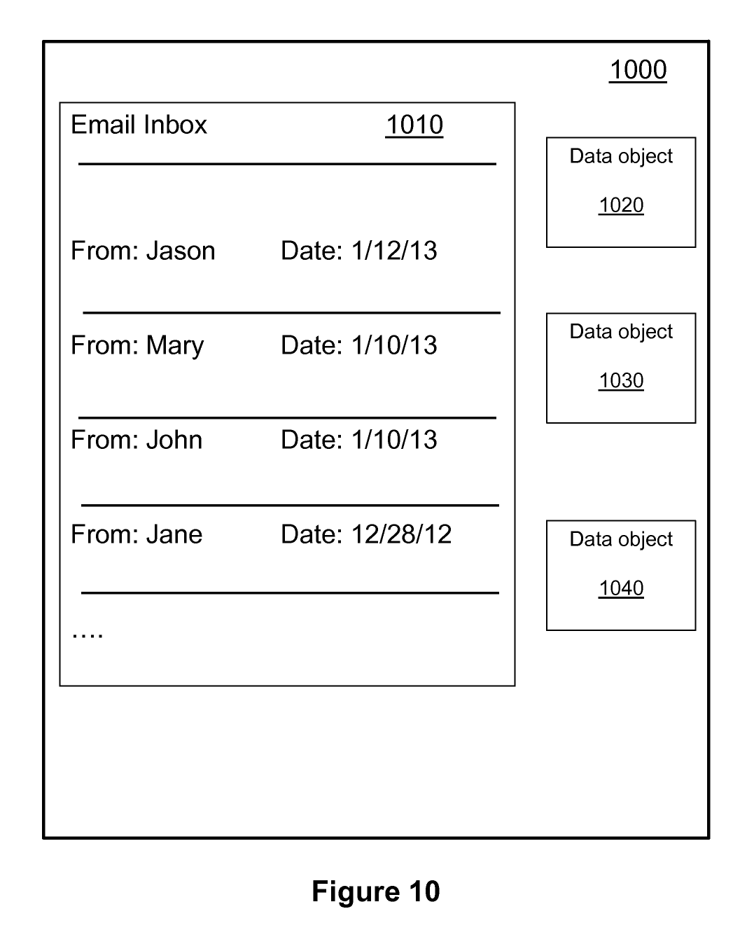

FIG. 10 illustrates an example of the present invention in using a company's email interface to deliver such messages. In this example, the user is viewing an email interface 1000, which comprises an email inbox folder 1010, and data objects 1020, 1030, and 1040 are displayed alongside in a separate panel but on the same page. Data objects can also be displayed on a separate page, website, or application altogether. Data objects can include information about health tips, company-sponsored health-maintenance activities, available health benefit resources, periodic health check reminders, drug and nutrition information, employee relationships, etc.

In some embodiments, messages from management can also be delivered in such a format. Such messages can include an organization's operational topics, such as highlights or reminders of company policies and guidelines, agendas, events, and announcements.

The messages delivered in such systems can be limited to company employees only, and can be governed by the organization's policy and pre-approved by the organization.

In some embodiments, the messages are sent or placed in the system for display by a limited number of designated persons in the management team of the organization.

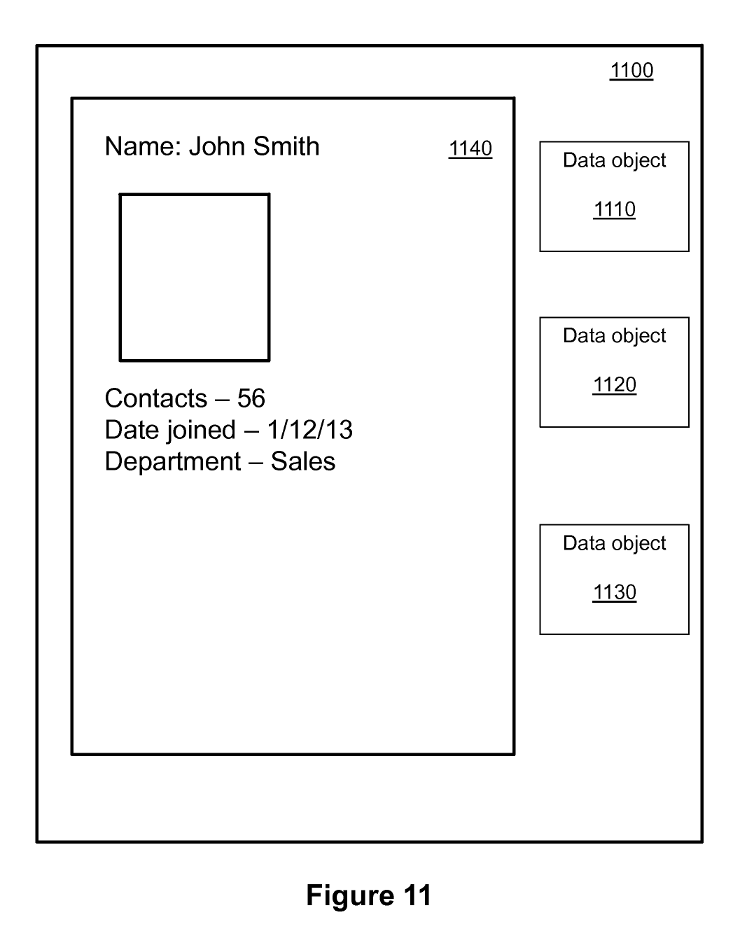

In some embodiments, the ads-like message objects can be tailored to specific users. Usually company human resources have certain information about an employee, which can serve as a type of user profile, and customized message objects can be delivered to the appropriate users using such a format. For example, in an enterprise social network or forum, users can have a user profile with related information about the user, such as health information, employee information, etc. Traditionally many social networks and email systems analyze similar information to determine what type of advertising to show to users within the network. The present system can analyze a user profile as well as what a user has written within the enterprise social network, and display information such as recommended health tips, company events, activities, reminders, relevant articles, etc, based on the data within a user interface in the enterprise network. FIG. 11 illustrates an example of the present embodiment where data objects 1110, 1120, and 1130 are displayed in a user's home page, where some information reflects a user's profile 1140 in a user interface 1100 within an enterprise social network. User's home page 1140 can comprise of basic user information, such as name, profile picture, department, etc. Other user information can also be stored within the system. The system can analyze user information along with what a user has said within the network to determine what data objects to display. Data objects 1110, 1120, or 1130 can be health information, company events, related activities, reminders, projects deadlines, etc. In FIG. 11, data objects are illustrated as being displayed in the same user interface with the user's home page. In some other embodiments, data objects can also be displayed in separate webpages on different parts of the site, or even in a separate website or application.

The above are only examples illustrating the various embodiments of the present invention. It should be understood that the methods disclosed above are not limited to the examples, and the basic principles of the present invention can be applied to various other cases or with variations in formats without deviating from the principles and the spirit of the present invention.

What is claimed is:

1. A method for presenting information related to a term or symbol, comprising:
receiving a text content containing one or more terms each comprising one or more words or phrases or sentences, wherein the text content is being displayed to a user in a user interface, wherein the text contents include documents or emails or webpages, or other contents containing text;
defining a term importance measure as a criterion for selecting terms in the text content for automatically presenting information related to the term, wherein the importance measure is based on information inside the text content;
identifying a first term in the text content, wherein the first term meets the criterion;
matching the first term with an entry in a data source containing one or more data units; wherein the data source can be a search index, or a relational or non-relational database;
automatically retrieving a data unit associated with the matched entry from the data source.

2. The method of claim 1, further comprising:
automatically displaying the data unit in a user interface in connection with the text content.

3. The method of claim 2, wherein the first term and the data unit can be concurrently viewed in the user interface.

4. The method of claim 2, wherein the data unit is displayed in a separate display area, or in a viewing object associated with the first term.

5. The method of claim 1, wherein the importance measure of the term in the text content is based on the frequency of the term occurring in the text content.

6. The method of claim 1, wherein the importance measure of the term in the text content is based on a grammatical attribute associated with the term in the text content, wherein the grammatical attribute includes parts of speech or grammatical roles, wherein the parts of speech include at least a noun, a pronoun, a verb, an adjective, an adverb, a preposition; wherein the grammatical roles include at least a subject, a predicate, an object, a predicative, a sub-component of a multi-word phrase, a modifier in a phrase, a head of a phrase.

7. The method of claim 6, wherein a weighting co-efficient is assigned to the term based on the grammatical attribute associated with the term, wherein the importance measure of the term is further based on the weighting co-efficient.

8. The method of claim 1, wherein the importance measure of the term in the text content is based on a semantic attribute associated with the term.

9. The method of claim 1, wherein the first term can be displayed with a special visual effect, wherein the special visual effect includes highlighting or flashing.

10. The method of claim 1, wherein the data source is a document search index, wherein the data unit displayed can be a text string extracted from a document containing the first term instead of a link to the document; or wherein the data source is a database, wherein the data unit can be obtained by a database query operation, wherein the data unit can include numbers, strings, charts, and reports.

11. A method for presenting information related to a term or symbol, comprising:
receiving a text content containing one or more terms each comprising one or more words or phrases or sentences, wherein the text content is being displayed to a user in a user interface;
defining a criterion for automatically presenting information related to a term, wherein the criterion is based on a user action on the term;
identifying a first term in the text content, wherein the first term meets the criterion;
matching the first term with an entry in a data source containing one or more data units;
automatically retrieving a data unit associated with the matched entry from the data source; and
displaying the data unit in a user interface in connection with the text content, wherein the first term and the data unit can be concurrently viewed in the user interface, wherein the data unit can be viewed in a separate display area in the same user interface, or in a viewing object associated with the first term.

12. The method of claim 11, wherein the criterion is when a pointing device is moved over the term.

13. The method of claim 11, wherein the criterion is when the term is clicked by a pointing device or is touched on a touch screen.

14. The method of claim 11, wherein the criterion is when the term is selected by a user.

15. The method of claim 11, wherein the criterion is when the term is clicked by a pointing device or is touched on a touch screen or selected by a user, and an action for searching or displaying the information is indicated by a user.

16. The method of claim 15, wherein the term is a word of a multi-word phrase, the method further comprising:
providing an option for the user to either search based on the single word, or based on the multi-word phrase including the word.

17. The method of claim 11, wherein the data source is a document search index, wherein the documents include emails or other contents containing text, wherein the data unit displayed can be a text string extracted from a document containing the first term instead of a link to the document.

18. The method of claim 17, wherein the text string is extracted based on a grammatical relation between the first term and the text string.

19. The method of claim 18, wherein the grammatical relation is between a subject and a predicate, or a verb and a verbal complement including an object or a predicative.

20. The method of claim 19, wherein the data source is a database, wherein the data unit can be obtained by a database query operation, wherein the data unit can include numbers, strings, charts, and reports.
